(19) United States
(12) Patent Application Publication
(10) Pub. No.: US 2006/0132946 A1
(43) Pub. Date: Jun. 22, 2006

(54) Plasma display panel (PDP) assembly

(76) Inventors: Sok-San Kim, Suwon-si (KR); Ki-Jung Kim, Suwon-si (KR); Joong-Ha Ahn, Suwon-si (KR); Tae-Kyoung Kang, Suwon-si (KR); Myoung-Kon Kim, Suwon-si (KR)

Correspondence Address: ROBERT E. BUSHNELL, 1522 K STREET NW, SUITE 300, WASHINGTON, DC, 20005-1202, US

(21) Appl. No.: 11/229,581

(22) Filed: Sep. 20, 2005

(30) Foreign Application Priority Data
Dec. 17, 2004 (KR) 10-2004-108074

(51) Int. Cl. G02B 5/22

(52) U.S. Cl. 359/885

(57) ABSTRACT

A Plasma Display Panel (PDP) assembly includes: a panel assembly including a front panel and a rear panel disposed to face the front panel; a chassis base adapted to support the panel assembly; driving circuit units adapted to be attached to the chassis base; flexible printed cables adapted to have both ends electrically connected to terminals of electrodes of the panel assembly and connectors of the driving circuit units, to transmit an electrical signal; a filter assembly adapted to be attached to an exterior surface of the filter assembly; protection units adapted to be attached to the filter assembly, to ground the filter assembly, and to dissipate heat generated during an operation of the panel assembly; and a case adapted to accommodate the panel assembly, the chassis base, the driving circuit units, the flexible printed cables, the filter assembly, and the protection unit.

### CLAIM OF PRIORITY

This application makes reference to, incorporates the same herein, and claims all benefits accruing under 35 U.S.C. § 119 from an application for PLASMA DISPLAY PANEL ASSEMBLY earlier filed in the Korean Intellectual Property Office on the 17 of Dec., 2004 and there duly assigned Serial No. 10-2004-0108074.

### BACKGROUND OF THE INVENTION

1. Field of the Invention

The present invention relates to a Plasma Display Panel (PDP) assembly, and more particularly, to a PDP assembly in which a filter assembly is attached directly to a front surface of a panel assembly and a unit supporting the filter assembly performs both a grounding function and a heat dissipating function.

2. Description of the Related Art

Typically, a PDP assembly denotes a flat display device in which a plurality of discharge electrodes are arranged on facing surfaces of a plurality of substrates. A discharge gas is injected into an enclosed discharge space defined by the substrates. A phosphor material of a phosphor layer is excited by ultraviolet rays produced in the discharge space due to the application of a voltage to each of the discharge electrodes, and an image is displayed using light emitted from the excited phosphor material.

Such a PDP assembly is manufactured by fabricating a front panel and a rear panel, combining them together, arranging a chassis base on the rear surface of the rear panel, installing base driving circuit units on a side of the chassis, the base driving circuit units transferring electrical signals with the panel assembly, and mounting these elements within a case.

A PDP assembly includes a panel assembly, a chassis base attached to the rear surface of the panel assembly by an adhesive member, chassis reinforcing members attached to upper and lower edges of the chassis base, driving circuit units attached to the chassis base, circuits mounted on the driving circuit units, cover plates attached to upper and lower edges of the chassis base, a flexible printed cable interposed between the chassis base and the cover plate, a filter assembly attached to a front side of the panel assembly, and a case for accommodating the panel assembly, the chassis base, the driving circuit unit, and the filter assembly. The panel assembly includes a front panel and a rear panel that are combined together.

The filter assembly is installed to block electromagnetic waves produced during operation, to prevent emission of light within an infrared wavelength band or neon light, or to prevent visibility degradation caused by reflection of external light. To achieve this, the filter assembly is formed by attaching an electromagnetic wave baffle filter, a selected wavelength absorbing film, a reflection prevention film, etc. onto a transparent substrate, such as, a glass substrate or a plastic substrate. The filter assembly is grounded to the chassis base.

A filter holder is interposed between the filter assembly and the panel assembly 101. The filter holder includes a press portion which presses the filter assembly against the case, and a fixing portion which is bent with respect to the press portion in a direction where the front and rear panels are arranged.

A filter fixing part is installed on a rear edge of the case so as to face the fixing portion of the filter holder. The filter fixing part is attached to the filter holder by screws, so that the filter assembly is fixed to the case.

However, the PDP assembly has the following problems. First, the filter assembly having a plurality of films on a centimeter-sized transparent substrate is interposed between the case and the filter holder, and the filter holder, which supports the filter assembly is then screwed to the filter fixing part attached to the case. If excessive external forces are applied during the attaching of the filter holder to the filter fixing part, the transparent substrate for the filter assembly can be damaged.

Second, because the filter assembly is formed by attaching a plurality of films to a transparent substrate, a transparent substrate for supporting the films is needed, and manufacturing costs increase.

Third, because the filter assembly needs a thick substrate, it runs counter to a trend toward developments of light, thin, short, and compact PDP assemblies.

Fourth, there is a need to block vibrations or noises generated from the inside of the PDP assembly.

Fifth, more stable grounding in which electromagnetic waves generated by the panel assembly pass into the ground is needed.

Sixth, the chassis base must be reinforced, resulting in a large PDP assembly.

Seventh, heat generated during an operation of the PDP assembly needs to be dissipated.

### SUMMARY OF THE INVENTION

The present invention provides a Plasma Display Panel (PDP) assembly in which a filter assembly is attached directly to a front surface of a panel assembly.

The present invention also provides a Plasma Display Panel (PDP) assembly including a protecting unit supporting a filter assembly, thereby ensuring stable electrical grounding and performing heat dissipating.

According to an aspect of the present invention, a Plasma Display Panel (PDP) assembly is provided comprising: a panel assembly including a front panel and a rear panel disposed to face the front panel; a chassis base adapted to support the panel assembly; driving circuit units adapted to be attached to the chassis base; flexible printed cables adapted to have both ends electrically connected to terminals of electrodes of the panel assembly and connectors of the driving circuit units, to transmit an electrical signal; a filter assembly adapted to be attached to an exterior surface of the filter assembly; protection units adapted to be attached to the filter assembly, to ground the filter assembly, and to dissipate heat generated during an operation of the panel assembly; and a case adapted to accommodate the panel assembly, the chassis base, the driving circuit units, the flexible printed cables, the filter assembly, and the protection unit.

The filter assembly preferably comprises a stack of films adapted to prevent reflection of electromagnetic waves generated by the panel assembly, infrared rays, neon light, or external light and adapted to be attached directly to a surface of the front panel.

The protection units are preferably adapted to be attached to upper and lower edges of the filter assembly and to include brackets electrically connected to the filter assembly and cover plates disposed a predetermined distance away from upper and lower edges of the chassis base and attached to the brackets.

Each of the brackets is preferably adapted to have one end parallel to the filter assembly and another end bent with respect to the one end at least once in a direction towards the chassis base.

Each of the cover plates is preferably adapted to have one end parallel to the chassis base and another end bent with respect to the one end in a direction towards the filter assembly.

The one end of each of the brackets is preferably adapted to be attached to the front surface of the filter assembly, and the another end is adapted to be attached to an end of each of the cover plates by a coupling unit.

The coupling unit preferably comprises a first coupling hole arranged in each of the brackets, a second coupling hole arranged in a part of each of the cover plates, the second coupling hole being in line with the first coupling hole, and a screw adapted to be inserted into the first and second coupling holes.

The PDP assembly preferably further comprises reinforcing members arranged in the cover plates or the brackets and adapted to reinforce the strengths of the cover plates or the brackets.

Each of the reinforcing members preferably comprises a bead or embossing through which the first or second coupling hole is adapted to penetrate.

The PDP assembly preferably further comprises guide units arranged in the cover plates or the brackets and adapted to serve as a guide during attachment of the cover plates and the brackets.

Each of the guide units preferably comprises one of a burring unit, a press fitted boss, and a protruding pin arranged on a bracket or a cover plate, and wherein the bracket and the cover plate are adapted to be attached together by inserting a screw into the guide unit.

The PDP assembly preferably further comprises a conductive material adapted to be interposed between the bracket and the filter assembly.

The conductive material preferably comprises one of an electromagnetic wave shield sponge and a finger strip.

Each of the cover plates is preferably adapted to have one end attached to the chassis base or a chassis reinforcing member installed in the rear of the chassis base to reinforce the strength of the chassis base and the another end attached to each of the brackets by a coupling unit.

The PDP assembly preferably further comprises flexible printed cables adapted to be interposed between the cover plates and the chassis bases or chassis reinforcing members.

The PDP assembly preferably further comprises a sound absorbing material adapted to be interposed between the protection unit and the flexible printed cables.

The PDP assembly preferably further comprises a vibration reductive material adapted to be interposed between the protection unit and the flexible printed cables.

The PDP assembly preferably further comprises at least one heat sink adapted to be arranged on an exterior surface of the protection unit.

The protection unit preferably comprises brackets adapted to be attached to upper and lower edges of the filter assembly in a length direction of the filter assembly and electrically connected to the filter assembly.

The brackets are preferably adapted to be attached to one of the chassis base, the chassis reinforcing member, and the case.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a cross-section of a part of a PDP assembly;

FIG. 2 is an exploded perspective view of a plasma display device assembly according to an embodiment of the present invention;

FIG. 3 is a cross-section of a part of the PDP assembly of FIG. 2;

FIG. 4 is an exploded perspective view of the part shown in FIG. 3;

FIG. 5 is an exploded perspective view of a plasma display device assembly according to another embodiment of the present invention;

FIG. 6 is an exploded perspective view of a plasma display device assembly according to still another embodiment of the present invention;

FIG. 7 is an exploded perspective view of a plasma display device assembly according to yet another embodiment of the present invention;

FIG. 8 is an exploded perspective view of a plasma display device assembly according to a further embodiment of the present invention; and

FIG. 9 is an exploded perspective view of a plasma display device assembly according to still a further embodiment of the present invention.

### DETAILED DESCRIPTION OF THE INVENTION

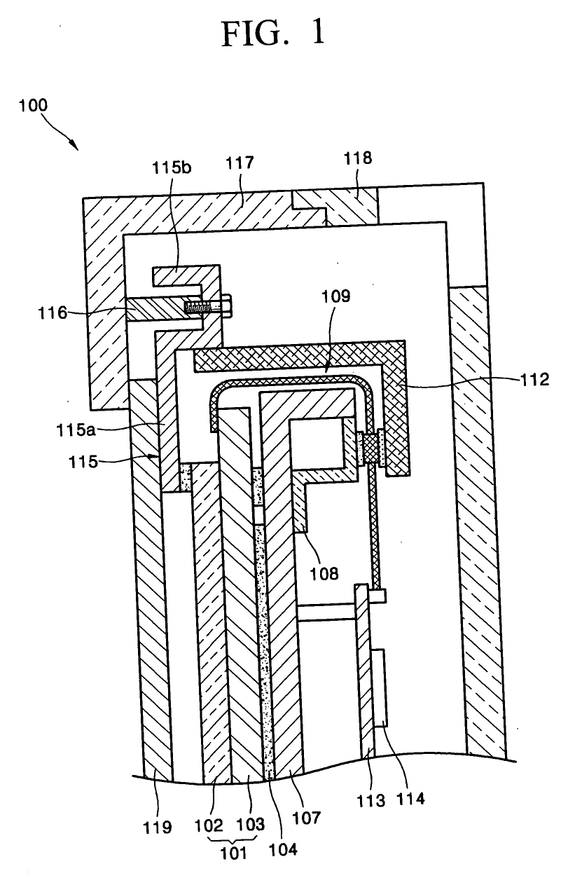

Referring to FIG. 1, a PDP assembly 100 includes a panel assembly 101, a chassis base 107 attached to the rear surface of the panel assembly 101 by an adhesive member 104, chassis reinforcing members 108 attached to upper and lower edges of the chassis base 107, driving circuit units 113 attached to the chassis base 107, circuits 114 mounted on the driving circuit units 113, cover plates 112 attached to upper and lower edges of the chassis base 107, a flexible printed cable 109 interposed between the chassis base 107 and the cover plate 112, a filter assembly 119 attached to a front side of the panel assembly 101, and a case 117 for accommodating the panel assembly 101, the chassis base 107, the driving circuit unit 113, and the filter assembly 119. The panel assembly 101 includes a front panel 102 and a rear panel 103 that are combined together.

The filter assembly 119 is installed to block electromagnetic waves produced during operation, to prevent emission of light within an infrared wavelength band or neon light, or to prevent visibility degradation caused by reflection of external light. To achieve this, the filter assembly 119 is formed by attaching an electromagnetic wave baffle filter, a selected wavelength absorbing film, a reflection prevention film, etc. onto a transparent substrate, such as, a glass substrate or a plastic substrate. The filter assembly 119 is grounded to the chassis base 107.

A filter holder 115 is interposed between the filter assembly 119 and the panel assembly 101. The filter holder 115 includes a press portion 115a, which presses the filter assembly 119 against the case 117, and a fixing portion 115b, which is bent with respect to the press portion 115a in a direction where the front and rear panels 102 and 103 are arranged.

A filter fixing part 116 is installed on a rear edge of the case 117 so as to face the fixing portion 115b of the filter holder 115. The filter fixing part 116 is attached to the filter holder 115 by screws, so that the filter assembly 119 is fixed to the case 117.

However, the PDP assembly 100 has the following problems. First, the filter assembly 119 having a plurality of films on a centimeter-sized transparent substrate is interposed between the case 117 and the filter holder 115, and the filter holder 115, which supports the filter assembly 119, is then screwed to the filter fixing part 116 attached to the case 117. If excessive external forces are applied during the attaching of the filter holder 115 to the filter fixing part 116, the transparent substrate for the filter assembly 119 can be damaged.

Second, because the filter assembly 119 is formed by attaching a plurality of films to a transparent substrate, a transparent substrate for supporting the films is needed, and manufacturing costs increase.

Third, because the filter assembly 119 needs a thick substrate, it runs counter to a trend toward developments of light, thin, short, and compact PDP assemblies.

Fourth, there is a need to block vibrations or noises generated from the inside of the PDP assembly 100.

Fifth, more stable grounding in which electromagnetic waves generated by the panel assembly 101 pass into the ground is needed.

Sixth, the chassis base 107 must be reinforced, resulting in a large PDP assembly 100.

Seventh, heat generated during an operation of the PDP assembly 100 needs to be dissipated.

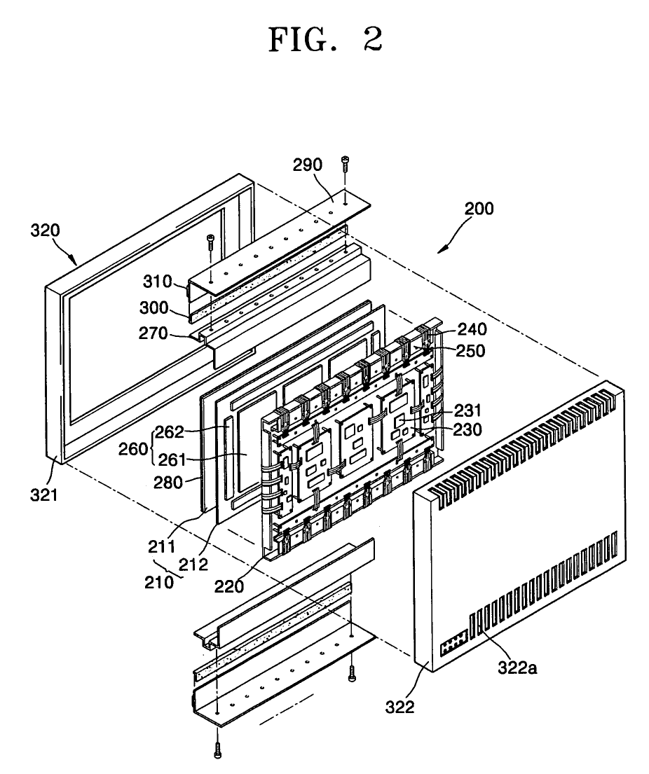

FIG. 2 illustrates a plasma display device assembly 200 according to an embodiment of the present invention. Referring to FIG. 2, the plasma display device assembly 200 includes a panel assembly 210, which includes a front panel 211 and a rear panel 212 combined with the front panel 211.

When the panel assembly 210 is a three-electrode Alternating Current (AC) PDP, discharge sustain electrode pairs, each including an X electrode and a Y electrode, a front dielectric layer in which the discharge sustain electrode pairs are buried, and a protective layer with which a surface of the front dielectric layer is coated are formed on the inner surface of the front panel 211.

Address electrodes arranged to be orthogonal to the discharge sustain electrode pairs and a rear dielectric layer in which the address electrodes are buried are formed on the rear panel 212. Barrier ribs that define discharge cells are arranged between the front and rear panels 211 and 212. Sidewalls of the barrier ribs are coated with red, green, and blue phosphor layers.

A chassis base 220 is disposed at the rear of the panel assembly 210 and attached to the panel assembly 210 by an adhesive 260. The chassis base 220 is a highly thermal-conductive aluminum plate. The adhesive 260 includes dissipation sheets 261 and double-sided tapes 262. Chassis reinforcing members 250 are attached to rear sides of the upper and lower edges of the chassis base 220 to reinforce the chassis base 220.

A plurality of driving circuit units 230 are attached to the rear surface of the chassis base 220. A plurality of circuit elements 231 are attached to each of the driving circuit units 230. Flexible printed cables 240 are installed between the driving circuit units 230 and the panel assembly 210. The flexible printed cables 240 electrically connect the terminals of the electrodes of the panel assembly 210 with connectors of the driving circuit units 230.

A filter assembly 280 is attached to the front side of the panel assembly 210. The filter assembly 280 prevents reflection of electromagnetic waves generated by the panel assembly 210, infrared rays, neon light, or external light.

The panel assembly 210, the chassis base 220, the driving circuit units 230, and the filter assembly 280 are contained within a case 320. The case 320 includes a front cabinet 321, which is arranged in front of the filter assembly 280, and a back cover 322, which is arranged in the rear of the driving circuit units 230. A plurality of through holes 322a are formed in upper and lower edges of the back cover 322.

According to features of the present invention, the filter assembly is attached directly to the outer surface of the panel assembly 210, and protection units are attached to the filter assembly 280 and the chassis base 220 to ground electricity generated by the filter assembly 280 and discharge heat received from the chassis base 220.

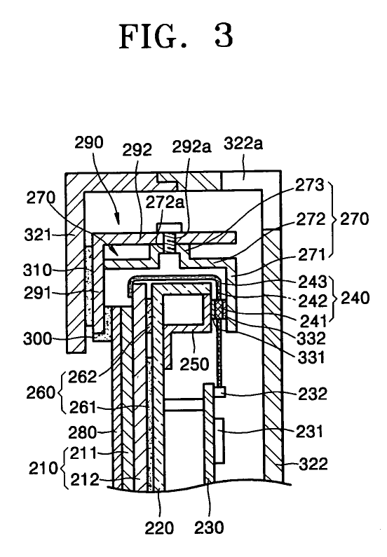

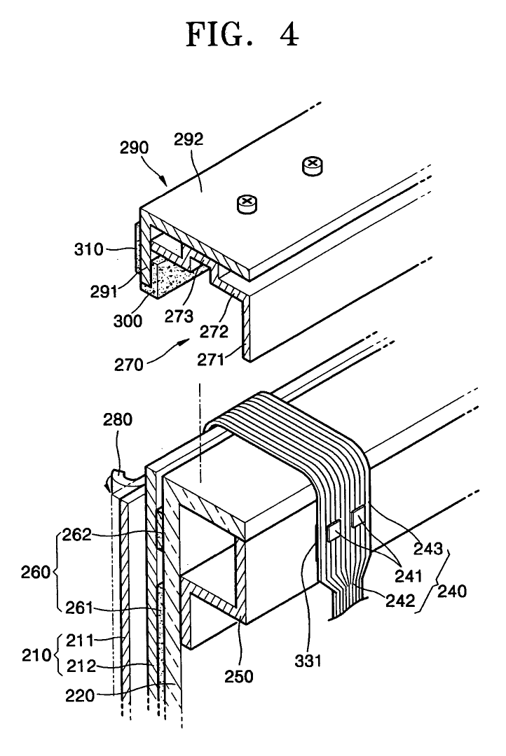

FIG. 3 is a cross-section of a part of the PDP assembly 200 of FIG. 2 and FIG. 4 is an exploded perspective view of the part shown in FIG. 3. Referring to FIGS. 3 and 4, the panel assembly 210 is formed by arranging the front panel 211 and the rear panel 212 to face each and to be spaced apart by a predetermined distance and to seal them together.

The chassis base 220 is attached to the rear side of the rear panel 212. The chassis base 220 does not only support the panel assembly 210 but also dissipates heat generated by the panel assembly 210 during operation. Upper and lower edges of the chassis base 210 are bent in the shape of “L” in the direction away from the panel assembly 210 to reinforce the chassis base 210.

The adhesive 260 is interposed between the rear panel 212 and the chassis base 220. The dissipation sheets 261 included in the adhesive 260 are arranged in the center of the rear panel 212, and the double-sided tapes 262 included therein are arranged on the periphery of the rear panel 212. The dissipation sheets 261 transfer the heat generated by the panel assembly 210. When the panel assembly 210 is attached to the chassis base 220, the dissipation sheets 261 not only dissipate the heat but also attach the panel assembly 210 to the chassis base 220.

The chassis reinforcing members 250 are attached to rear surfaces of the upper and lower edges of the chassis base 220 in a length direction of the chassis base 220 to prevent the chassis base 220 from being deformed upward and downward due to the enlargement of the panel assembly 210. Alternatively, the chassis reinforcing members 250 can be attached to rear surfaces of the left and right edges of the chassis base 220 in a width direction of the chassis base 220. The chassis reinforcing members 250 are strip-shaped plates that are bent at least once. In compact PDP assemblies having no chassis reinforcing members 250, the chassis base 220 itself can be bent at least once.

The driving circuit units 230 are attached to the rear surface of the chassis base 220. Each of the driving circuit units 230 includes the plurality of circuit elements 231 and a connector 232.

The filter assembly 280 is attached to the front surface of the panel assembly 210. In other words, the filter assembly 280 is attached directly to the front surface of the front panel 211 to block electromagnetic waves generated by the panel assembly 210 and to prevent emission of ultraviolet rays or neon light and reflection of external light.

To do this, the filter assembly 280 is formed by repeatedly stacking a reflection preventing film for preventing visibility degradation due to reflection of the external light, an electromagnetic wave shielding film for effectively shielding the electromagnetic waves generated while the panel assembly 210 is being driven, a selected wavelength absorbing film for shielding unnecessary emission of near-infrared rays due to inert plasma used upon neon emission and screen light-emission. The filter assembly 280 does not include a thick transparent glass or plastic substrate in contrast with a conventional filter assembly.

Protection units are coupled to the filter assembly 280 and the chassis base 220. In other words, brackets 290 are attached to upper and lower edges of the filter assembly 280 in a length direction of the filter assembly 280. The brackets 290 are electrically connected to the filter assembly 280. The cover plates 270 are installed on the upper and lower edges of the chassis base 220 to be a predetermined distance away from the chassis base 220. The cover plates 270 are attached to the brackets 270. The flexible printed cables 240 are arranged in a space between the resultant chassis base 220 and the cover plate 290.

Each of the brackets 290 includes a first bent portion 291, which is parallel to the filter assembly 280, and a second bent portion 292, which is bent 90° with respect to the first bent portion 291 in a direction towards the chassis base 220. Each of the cover plates 270 includes a third bent portion 271, which is parallel to the chassis base 220, and a fourth bent portion 272, which is bent 90° with respect to the third bent portion 271 in a direction towards the filter assembly 280.

One edge of the first bent portion 291 of the bracket 290 attached to the upper edge of the first assembly 280 is attached to the upper edge of the front side of the filter assembly 280. The other edge of the second bent portion 292 is attached to the fourth bent portion 272 of the cover plate 270 by a coupling unit.

Preferably, but not necessarily, a conductive material 300 is interposed between the first bent portion 291 and the upper edge of the front side of the filter assembly 280. Examples of the conductive material 300 include an electronic wave shield sponge, a finger strip, etc. The conductive material 300 has an excellent conductivity, restorability, and an electronic wave shield percentage, and has a low contact resistance even over time. The brackets 290 are attached to the front cabinet 321 by adhesives 310.

Accordingly, the brackets 290 can be electrically connected either directly to the filter assembly 280 or to the filter assembly 280 via the conductive material 300 to perform a grounding function.

A first coupling hole 292a can be formed in the second bent portion 291 of the bracket 290, and a second coupling hole 272a can be formed in the fourth bent portion 272 of the cover plate 270. Hence, the bracket 290 and the cover plate 270 can be attached together by inserting a screw into the first and second coupling holes 292a and 272a.

The cover plate 270 can further include a reinforcing unit to reinforce the coupling. In this embodiment, a bead 273 is formed in the fourth bent portion 272 of the cover plate 270. Alternatively, the bead 273 can be formed in the second bent portion 292 of the bracket 290, and either the cover plate 270 or the bracket 270 can be embossed.

The present invention is not limited to this embodiment. For example, in PDP assemblies not including the cover plates 270, the chassis base 220 or the chassis reinforcing member 250 can be bent at least once and attached to the brackets 290 by a coupling unit or a reinforcing unit.

The flexible printed cables 240 are interposed between the chassis reinforcing members 250 and the cover plates 270. Each of the flexible printed cables 240 includes an IC 241, a lead 242, and a film 243 with which the lead 242 is coated. The lead 242 is electrically 2 connected to the IC 241, has one end connected to the terminals of the electrodes of the panel 3 assembly 210 and the other end connected to the connectors 232 of the driving circuit units 230, 4 and transfers electrical signals between the panel assembly 210 and the driving circuit units 230.

An adhesive 331, such as, thermal grease, is interposed between the IC 241 and the chassis reinforcing member 250. The heat sinks 332, such as, silicon sheets, are interposed between the ICs 241 and the cover plates 270.

In the PDP assembly 200 having such a structure, electromagnetic waves generated by the panel assembly 210 or the circuit elements 231 are blocked by the electromagnetic wave shield film of the filter assembly 280 attached directly to the front surface of the front panel 211. The electromagnetic waves are removed via the conductive material 300, which is electrically connected to the electromagnetic wave shield film, the brackets 290, and the front cabinets 321.

Unnecessary near-infrared rays emitted due to inert plasma used upon neon emission and screen light-emission are absorbed by the selected wavelength absorbing film. Visibility degradation due to reflection of external light can be reduced by the reflection preventing film.

In the PDP assembly 200, a great amount of heat is generated by the panel assembly 210 during operation. The heat passes through the dissipation sheets 261 interposed between the panel assembly 210 and the chassis base 220 and is dissipated through the chassis base 220.

Heat generated by the ICs 241 of the flexible printed cables 240 passes through the heat sinks 332 and the cover plates 270 and is then dissipated through the brackets 290 attached to the cover plates 270. The dissipated heat is removed by natural convection of air entering through the through holes 322a formed in the back cover 322.

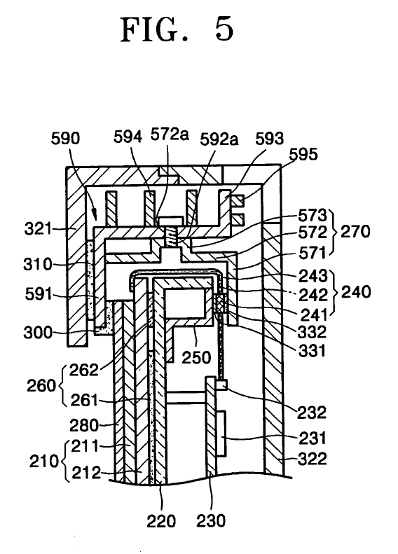

FIG. 5 is an exploded perspective view of a plasma display device assembly according to another embodiment of the present invention. Referring to FIG. 5, the filter assembly 280, which is formed by stacking a plurality of functional films without a transparent glass or plastic substrate, is attached directly to the front surface of the panel assembly 210. The chassis base 220 is attached to the rear side of the panel assembly 210 by the adhesive 260.

The chassis reinforcing member 250 is attached to an upper part of the rear surface of the chassis base 220 to reinforce the chassis base 220. The driving circuit units 230, on each of which a plurality of circuit elements 231 are mounted, are arranged in the middle of the rear surface of the chassis base 220.

The filter assembly 280 attached to the front surface of the panel assembly 210 is supported by a protection unit.

In other words, the protection unit includes brackets 590 attached to the front surface of the filter assembly 280 by interposing an adhesive or the conductive material 300 between the brackets 590 and the filter assembly 280. Each of the brackets 590 includes a first bent portion 591, which is parallel to the filter assembly 280, a second bent portion 592, which is bent with respect to the first bent portion 591 in a direction towards the chassis base 220, and a third bent portion 593, which is bent with respect to the second bent portion 592 in a direction away from the direction where the first bent portion 591 is bent.

Cover plates 570 are arranged in the upper rear of the chassis base 220. The brackets 590 are attached to the cover plates 570. Each of the cover plates 570 includes a third bent portion 571, which is parallel to the chassis base 220, and a fourth bent portion 572, which is bent with respect to the third bent portion 571 in a direction towards the filter assembly 280.

The lower edge of the first bent portion 591 of the bracket 290 attached to the upper edge of the first assembly 280 is electrically connected to the filter assembly 280 by the conductive material 300, for example, an electromagnetic wave baffle sponge or a finger strip, interposed between the lower edge of the first bent portion 591 and the upper edge of the front side of the filter assembly 280.

To attach the second and fourth bent portions 592 and 572 together, a first coupling hole 592a is formed in the second bent portion 592, and a second coupling hole 572a is formed in the fourth bent portion 572 to be in line with the first coupling hole 592a. The second and fourth bent portions 592 and 572 are attached together by inserting a screw into the first and second coupling holes 592a and 572a. A bead 573 protrudes from the fourth bent portion 572 to reinforce the strength of the attached portion of the second and fourth bent portions 592 and 572. The second coupling hole 572a penetrates the bead 273.

The protection unit further includes heat dissipation units which effectively dissipate heat generated by the panel assembly 210, the driving circuit units 230 on which the circuit elements 231 are mounted, and the ICs 241 of the flexible printed cables 240.

In other words, a first heat sink 594, consisting of a plurality of ribs, is formed on the outer surface of the second bent portion 592. Likewise, a second heat sink 595, consisting of a plurality of ribs, is formed on the outer surface of the third bent portion 593.

Heat generated while a PDP assembly operates is effectively dissipated through an area extended by the installation of the cover plates 570 and the brackets 590 attached to the cover plates 570. The heat is rapidly dissipated by the first and second heat sinks 594 and 595.

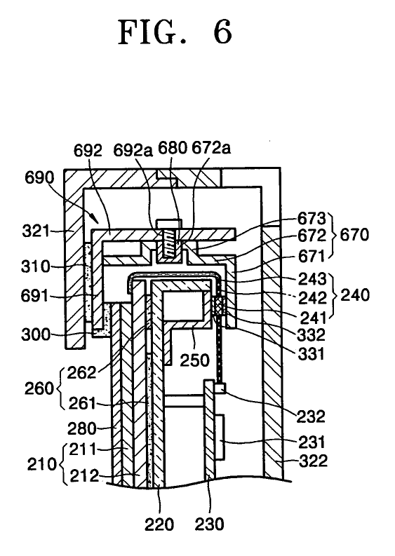

FIG. 6 is an exploded perspective view of a plasma display device assembly according to still another embodiment of the present invention. Referring to FIG. 6, the filter assembly 280 is attached directly to the front surface of the panel assembly 210 and supported by a protection unit.

In other words, the protection unit includes brackets 690, which support the front side of the filter assembly 280, and cover plates 670, which are installed in the rear of the chassis base 220 and attached to the brackets 690. When no cover plates 670 are installed, the brackets 690 can extend upwards to locations where the cover plates 670 are to be positioned. Alternatively, the chassis base 220 and the chassis reinforcing member 250 are modified to be attached to the brackets 690.

Each of the brackets 690 includes a first bent portion 691, which is parallel to the filter assembly 280, and a second bent portion 692, which is bent with respect to the first bent portion 691 in a direction towards the chassis base 220. Each of the cover plates 670 includes a third bent portion 671, which is parallel to the chassis base 220, and a fourth bent portion 672, which is bent with respect to the third bent portion 671 in a direction away from the filter assembly 280.

The second and fourth bent portions 692 and 672 face each other, and a first coupling hole 692a is formed in the second bent portion 692. A bead 673 protrudes from the fourth bent portion 672, and a boss 680 serving as a guide is press fitted into the second coupling hole 672a formed in the bead part 673. Because the boss 680 serves as a guide, the fourth bent portion 672 can be attached to the second bent portion 692.

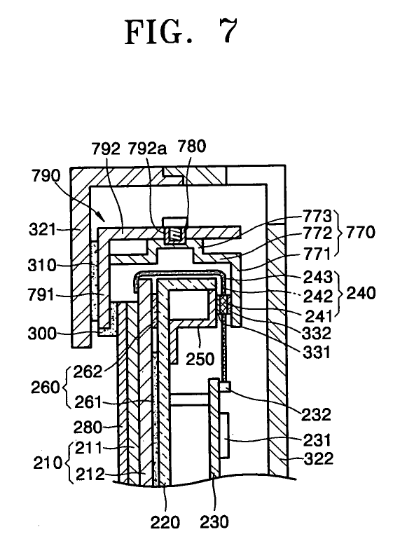

FIG. 7 is an exploded perspective view of a plasma display device assembly according to yet another embodiment of the present invention. Referring to FIG. 7, the filter assembly 280 is attached directly to the front surface of the panel assembly 210 and supported by a protection unit. The protection unit includes brackets 790 and cover plates 770 attached to the brackets 790.

Each of the brackets 790 includes a first bent portion 791, which is attached to the front surface of the filter assembly 280, and a second bent portion 792, which is bent with respect to the first bent portion 791 in a direction towards the chassis base 220. Each of the cover plates 770 includes a third bent portion 771, which is attached to the rear surface of the chassis base 220, and a fourth bent portion 772, which is bent with respect to the third bent portion 771 in a direction towards the filter assembly 280.

The second and fourth bent portions 792 and 772 face each other, and a first coupling hole 792a is formed in the second bent portion 792. A bead 773 protrudes from the fourth bent portion 772 to reinforce the strength of the fourth bent portion 772. A pin 780 serving as a guide extends from the bead 773, and the second and fourth bent portions 792 and 772 are attached together by the pin 780.

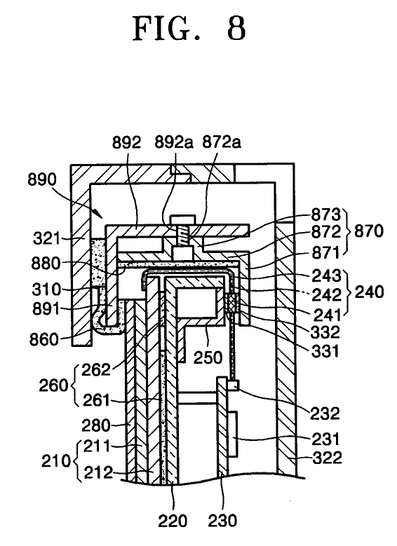

FIG. 8 is an exploded perspective view of a plasma display device assembly according to further embodiment of the present invention. Referring to FIG. 8, the filter assembly 280 is attached directly to the front surface of the panel assembly 210 and supported by a protection unit. The protection unit includes brackets 890, which are attached to the front side of the filter assembly 280, and cover plates 870, which are installed in the rear of the chassis base 220 and attached to the brackets 890.

Each of the brackets 890 includes a first bent portion 891, which is electrically connected to the front surface of the filter assembly 280 by a conductive material 860, for example, a finger strip, interposed between the first bent portion 891 and the front surface of the filter assembly 280, and a second bent portion 892, which is bent with respect to the first bent portion 891 in a direction towards the chassis base 220 and attached to a fourth bent portion 872 of each of the cover plates 870.

To obtain this structure, a first coupling hole 892a is formed in the second bent portion 892. A bead 873 protrudes from the fourth bent portion 872, and a second coupling hole 872a is formed in the bead part 873 to be in line with the first coupling hole 892a. The second and fourth bent portions 892 and 872 are attached together by inserting a screw into the first and second coupling holes 892a and 872a.

A unit 880 for blocking vibrations or noises generated during an operation of a PDP assembly, for example, a vibration reductive material or a sound absorbing material, is installed on the inner surface of the fourth bent portion 872.

The unit 880 for blocking such vibrations or noises is located opposite to the flexible printed cable 240 to protect it. The unit 880 can be a sponge, a rubber, a nonwoven fabric, etc.

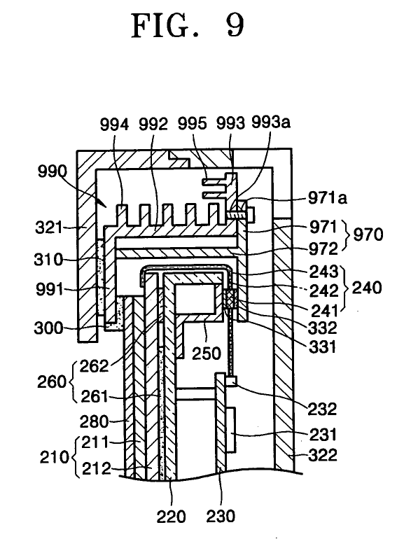

FIG. 9 is an exploded perspective view of a plasma display device assembly according to further embodiment of the present invention. Referring to FIG. 9, a filter assembly 280 formed by stacking a plurality of films is attached directly to the front surface of the panel assembly 210 and supported by a protection unit. The protection unit includes brackets 890, which are attached to the front side of the filter assembly 280, and cover plates 970, which are installed in the rear of the chassis base 220 and attached to the brackets 990.

Each of the brackets 990 includes a first bent portion 991, which is parallel to the filter assembly 280, a second bent portion 992, which is bent with respect to the first bent portion 991 in a direction towards the chassis base 220, and a third bent portion 993, which is bent with respect to the second bent portion 992 in the direction opposite to the direction in which the first bent portion 991 is bent.

Each of the cover plates 970 includes a fourth bent portion 971, which is parallel to the chassis base 220, and a fifth bent portion 972, which is bent 90° with respect to the third bent portion 571 at the middle point thereof in a direction towards the filter assembly 280.

To attach the third and fourth bent portions 993 and 971 together, a first coupling hole 993a is formed in the third bent portion 993, a second coupling hole 971a is formed in the upper end of the fourth bent portion 971, and a screw is inserted into the first and second coupling holes 993a and 971a. A first heat sink 994, consisting of a plurality of ribs, is formed on the outer surface of the second bent portion 992. A second heat sink 995, consisting of a plurality of ribs, is formed on the inner surface of the third bent portion 993.

In a PDP assembly according to the present invention as described above, a filter assembly is attached directly to the front surface of a panel assembly and supported by a separate protection unit, thus having the following effects. First, the direct attachment of the filter assembly to the panel assembly does not require a transparent glass or plastic substrate. Thus, the PDP assembly becomes lighter, thinner, and more compact and can be simply manufactured at reduced costs.

Second, the filter assembly is electrically connected to and supported by brackets included in the protection unit. Thus, electrical grounding can be stably ensured.

Third, the brackets, which support the filter assembly, are attached to cover plates attached to a chassis base, thereby serving as a heat discharging element.

Fourth, a conductive material is interposed between the filter assembly and each of the brackets to improve electromagnetic wave shielding.

Fifth, the inclusion of a vibration reduction material or a sound absorbing material within a case, reduces vibrations or noises generated from the inside of the PDP assembly.

Sixth, the installation of a bead unit, an embossing unit, a boss unit, or a burring unit in the brackets or cover plates causes the strengths of the brackets or cover plates to be reinforced.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Plasma Display Panel (PDP) assembly comprising:
a panel assembly including a front panel and a rear panel disposed to face the front panel;
a chassis base adapted to support the panel assembly;
driving circuit units adapted to be attached to the chassis base;
flexible printed cables adapted to have both ends electrically connected to terminals of electrodes of the panel assembly and connectors of the driving circuit units, to transmit an electrical signal;
a filter assembly adapted to be attached to an exterior surface of the filter assembly;
protection units adapted to be attached to the filter assembly, to ground the filter assembly, and to dissipate heat generated during an operation of the panel assembly; and
a case adapted to accommodate the panel assembly, the chassis base, the driving circuit units, the flexible printed cables, the filter assembly, and the protection unit.

2. The PDP assembly of claim 1, wherein the filter assembly comprises a stack of films adapted to prevent reflection of electromagnetic waves generated by the panel assembly, infrared rays, neon light, or external light and adapted to be attached directly to a surface of the front panel.

3. The PDP assembly of claim 1, wherein the protection units are adapted to be attached to upper and lower edges of the filter assembly and to include brackets electrically connected to the filter assembly and cover plates arranged away from upper and lower edges of the chassis base and attached to the brackets.

4. The PDP assembly of claim 3, wherein each of the brackets is adapted to have one end parallel to the filter assembly and another end bent with respect to the one end at least once in a direction towards the chassis base.

5. The PDP assembly of claim 3, wherein each of the cover plates is adapted to have one end parallel to the chassis base and another end bent with respect to the one end in a direction towards the filter assembly.

6. The PDP assembly of claim 4, wherein the one end of each of the brackets is adapted to be attached to the front surface of the filter assembly, and the another end is adapted to be attached to an end of each of the cover plates by a coupling unit.

7. The PDP assembly of claim 5, wherein the one end of each of the brackets is adapted to be attached to the front surface of the filter assembly, and the another end is adapted to be attached to an end of each of the cover plates by a coupling unit.

8. The PDP assembly of claim 6, wherein the coupling unit comprises a first coupling hole arranged in each of the brackets, a second coupling hole arranged in a part of each of the cover plates, the second coupling hole being in line with the first coupling hole, and a screw adapted to be inserted into the first and second coupling holes.

9. The PDP assembly of claim 8, further comprising reinforcing members arranged in the cover plates or the brackets and adapted to strengthen the cover plates or the brackets.

10. The PDP assembly of claim 9, wherein each of the reinforcing members comprises a bead or embossing through which the first or second coupling hole is adapted to penetrate.

11. The PDP assembly of claim 8, further comprising guide units arranged in the cover plates or the brackets and adapted to serve as a guide during attachment of the cover plates and the brackets.

12. The PDP assembly of claim 11, wherein each of the guide units comprises one of a burring unit, a press fitted boss, and a protruding pin arranged on a bracket or a cover plate, and wherein the bracket and the cover plate are adapted to be joined together by inserting a screw into the guide unit.

13. The PDP assembly of claim 3, further comprising a conductive material adapted to be interposed between the bracket and the filter assembly.

14. The PDP assembly of claim 13, wherein the conductive material comprises one of an electromagnetic wave shield sponge and a finger strip.

15. The PDP assembly of claim 3, wherein each of the cover plates is adapted to have one end attached to the chassis base or a chassis reinforcing member installed in the rear of the chassis base to strengthen the chassis base and the another end attached to each of the brackets by a coupling unit.

16. The PDP assembly of claim 15, further comprising flexible printed cables adapted to be interposed between the cover plates and the chassis bases or chassis reinforcing members.

17. The PDP assembly of claim 1, further comprising a sound absorbing material adapted to be interposed between the protection unit and the flexible printed cables.

18. The PDP assembly of claim 1, further comprising a vibration reductive material adapted to be interposed between the protection unit and the flexible printed cables.

19. The PDP assembly of claim 1, further comprising at least one heat sink adapted to be arranged on an exterior surface of the protection unit.

20. The PDP assembly of claim 1, wherein the protection unit comprises brackets adapted to be attached to upper and lower edges of the filter assembly in a length direction of the filter assembly and electrically connected to the filter assembly.

21. The PDP assembly of claim 20, wherein the brackets are adapted to be attached to one of the chassis base, the chassis reinforcing member, and the case.
